(19) United States
(12) Patent Application Publication
(10) Pub. No.: US 2022/0022686 A1
(43) Pub. Date: Jan. 27, 2022

(54) CONTAINED SELF-HEATING PORTABLE CONTAINER

(71) Applicant: Jessica Kavini Tamil, Plano, TX (US)

(72) Inventor: Jessica Kavini Tamil, Plano, TX (US)

(21) Appl. No.: 16/986,405

(22) Filed: Aug. 6, 2020

Related U.S. Application Data
(60) Provisional application No. 63/055,968, filed on Jul. 24, 2020.

(51) Int. Cl. A47J 36/28; F24V 30/00; B65D 81/34

(52) U.S. Cl. CPC A47J 36/28; B65D 81/3484; F24V 30/00

(57) ABSTRACT

The present invention may be used for self-heating edible fluids without an external heating source, and no or minimal leakage or spilling. It may consist of a fully sealed container body that prevents the leakage or mixing of an activation substance and edible fluid. A body inside of the container may behave as conductive wall separating the activation substance and edible fluid to prevent mixing. The invention includes a chemical pack tool that may be punctured into the container and seal the punctured hole so the is no leakage. As the exothermic reaction takes place, a built-in vent or existing one-way valves/vents may be used to prevent excess pressure build up, and then pushed back in to fully seal the container again when it is no longer needed.

### BACKGROUND OF THE INVENTION

This invention relates to an apparatus for storing, transporting and accessing an edible fluid. The new portable container will have the ability to use chemical packs, where the chemical pack and substance used to activate the pack are fully contained and the container can be portable.

The use of Flameless Ration Heater (FRH) packs or any other existing chemical packs capable of producing an exothermic reaction when mixed with another substance may already be known. Chemicals used to produce exothermic reactions are frequently used in the production of food heating devices. FRH packs, specifically, are commonly used in Meal Ready to Eat (MRE) Flameless Heater packs for the military, as well as for camping to heat up food. However, these devices that make use of the heat produced by exothermic reactions may not provide the convenience of being fully sealed before, during, and after the reaction takes place, and without the risk of spilling the activation substance, or cross contamination of the activation substance and edible fluid that is to be heated.

### SUMMARY OF THE INVENTION

The present invention is directed to apparatus for portable heating up of an edible substance with no additional heating source, and no or minimal leakage or spilling. The apparatus will consist of a fully sealed container body that prevents the leakage or mixing of the activation substance and edible fluid. A body inside of the container will behave as conductive wall separating the activation substance and edible fluid to prevent the mixing of the two. A chemical pack will then be punctured into the container on the side with the activation substance, when the edible fluid needs to be heated. The puncture hole will be sealed so that the container remains fully sealed. A built-in vent or existing one-way valves/vents will be used to prevent excess pressure build up. This vent can be pulled out when needed and then pushed back in to fully seal the container again when it is no longer needed.

These and other features, aspects and advantages of the present invention will become better understood with reference to the following drawings, descriptions and claims.

### BRIEF DESCRIPTION OF THE DRAWINGS

FIG. 1 illustrates the transparent view of the container with one possible method for designing the conductive wall. It displays all the internal and external parts before the addition of other features, according to an embodiment of the invention;

FIG. 2 illustrates the view of the overall and transparent view of the container with another possible method for designing the conductive wall by starting out with two separate halves and attaching them together. It displays all the internal and external parts before the addition of other features, according to an embodiment of the invention;

FIG. 3 builds on FIG. 1 and illustrates a feature creating a difference in height between the two compartments of the container where they meet at the median, according to an embodiment of the invention;

FIG. 4 builds on FIG. 2 and illustrates the feature creating a difference in height between the two compartments of the container where they meet at the median, according to an embodiment of the invention;

FIG. 5 illustrates the feature on the top of the container, including the orifice and vent locations, according to an embodiment of the invention;

FIG. 6 illustrates a detailed view of the chemical pack tool, according to an embodiment of the invention;

FIG. 7 illustrates a detailed view of an extendable vent that can be used in replacement of an existing one-way valve, according to an embodiment of the invention;

FIG. 8 illustrates the process for how to properly use the different features of the device.

### DETAILED DESCRIPTION

The following detailed description represents the best currently contemplated modes for carrying out the invention. The description is not to be taken in a limiting sense but is made merely for the purpose of illustrating the general principles of the invention.

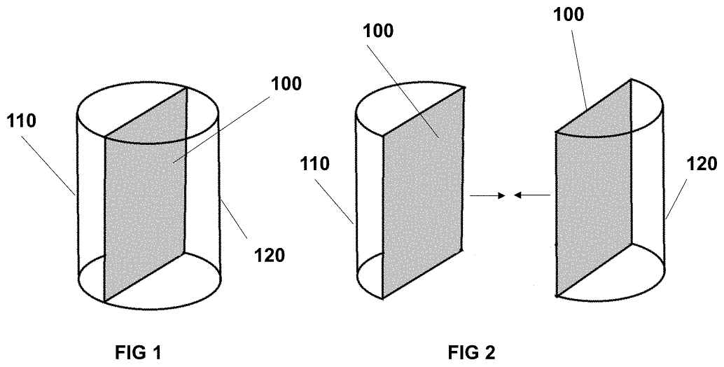

The overall basic container itself will be made of any material currently available to be used in the making of a container. It can be of any geometrical shape (cylindrical, cuboid, cubic, and any prism form). The basic container will have a conductive wall (100) inside forming two compartments. There can be two possible methods to forming the compartments inside the container, separated by the conductive wall. The first method shown in FIG. 1 consists of the basic container, that has the conductive wall (100) placed in the container and secured to form the two completely separated compartments. One compartment will be the activation chemical compartment (110) and will contain the activation chemical. The other compartment is the edible fluid compartment (120) and will contain the edible fluid. The second method for creating the compartments is shown in FIG. 2. It will consist of two halves of a container that each form a fully sealed compartment with their own conductive wall (100). One half will form the activation chemical compartment (110) that will contain the activation chemical, and the other halve will be the edible fluid compartment (120) that will contain the edible fluid. The two halves will be attached at the conductive walls (100) to form one conductive wall.

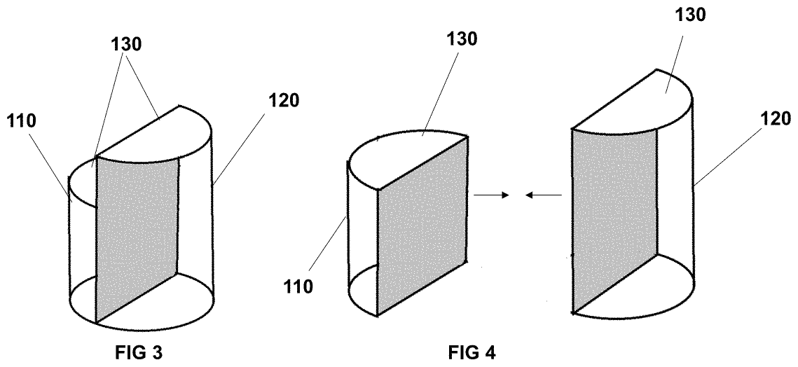

FIGS. 3 and 4 add a feature on to FIGS. 1 and 2 respectively. The activation chemical compartment (110) will be shorter than the edible fluid compartment (120). The tops of both compartments will be sealed with removable or unremovable lids (Lid 130). The reason the activation chemical compartment (110) is shorter than the edible fluid compartment (120), is prevent the fluid in activation chemical compartment (110), from contaminating the contents of the edible fluid compartment (120) after additional features such as the Hole with Breakable Seal for Chemical Pack (140), Hole for Vent (150), and Drinking Hole (160) are added. These holes can contribute to the fluid in the activation chemical compartment (110) leaking into the drinking hole (160) and contaminating the edible fluid.

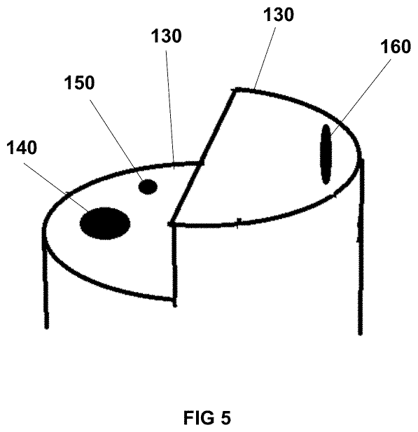

As shown on FIG. 5, the lid (130) on the activation chemical compartment (110) will contain two holes: hole with breakable seal for chemical pack (140) and hole for vent (150). The hole with breakable seal for chemical pack (140) will be covered with any penetrable seal that exists. This seal will act as a cover to prevent the fluid in the compartment from coming out of the hole, until the chemical pack tool (180) needs to be inserted. The second hole is the hole for Vent (150). This hole will either be fitted with a vent (240) or an existing one-way valve/vent. The lid on the edible fluid compartment (120) has a drinking hole (160) that is sealed with any existing removable seal available. This is the hole someone will drink the edible fluid through, and the seal will prevent leakage before the edible fluid is ready to drink.

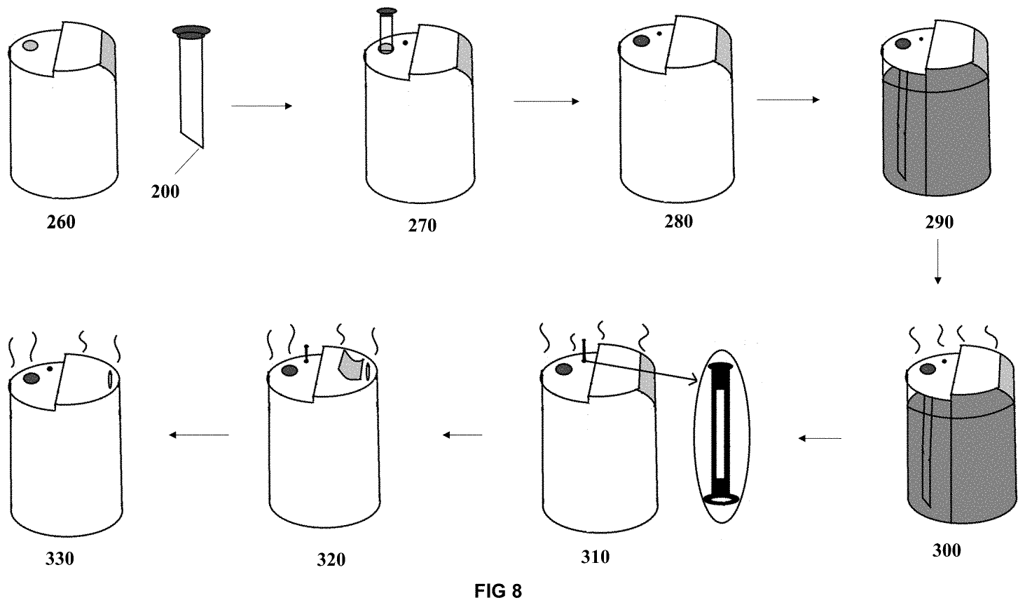

An embodiment of the vent (240) is shown in FIG. 7. This vent can be pulled up when pressure or steam needs to be released. The embodiment of the vent (240) will contain a wider vent base (230). This base is wider to prevent the vent from being completely pulled out when the vent is pulled up. The Vent will contain vent holes (210) that will allow for the steam to come out of the container. The top part of the vent (200) is wide like the vent base (230) and will snap into the container to seal it and also be used to pull the vent up.

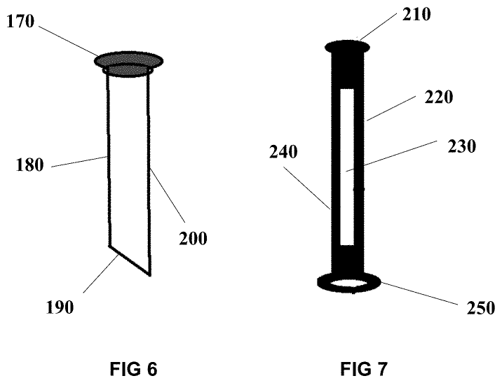

The chemical tool pack (180) shown in FIG. 6 will consist of a permeable cylindrical covering filled with the chemical to be activated (200) to allow for water to pass through, that will also be hard enough to maintain rigidity. The activation chemical will be contained inside this pack. The bottom part of the covering (190) will be hard and sharp enough to penetrate the seal covering the hole with breakable seal for chemical pack (140). There will be a seal (170) at the top of the chemical tool pack, which will be used to seal the chemical tool pack into the container and prevent any leakage.

The process for how the container will be used is mapped out in FIG. 8. The first item (260) shows the fully sealed container. All of the seals are currently still covering the openings to prevent leaks. The next item (270) shows the chemical tool pack (180) breaking the breakable seal and entering the hole with breakable seal for chemical pack (140). Item (280) shows the chemical tool pack (270) fully inserted into the hole until the seal locks and plugs up the hole with breakable seal for chemical pack (140). Item (290) shows a transparent view of how it looks inside of the container. The activation chemical compartment shows the chemical tool pack submerged in the activation chemical in the activation chemical compartment (110). The edible fluid compartment (120) shows the edible fluid. Item (300) shows another transparent view showing that the exothermic reaction is taking place between the chemical tool pack and activation chemical, is heating up the fluids in the container. Item (310) shows the vent (240) is pulled up to release any pressure build up or steam if there is too much pressure build up or heat. Again, this vent can be replaced by any one-way valve/vent than exists. Item (320) shows the cover has been removed from the drinking hole (160) above the edible fluid compartment (120) to allow the consumer to drink the edible fluid. The vent can be pushed back in as shown in item (330) to seal the vent hole. The consumer can now consume the warm/hot edible fluid without risk of contamination of the activation fluid in the edible fluid.

While the invention has been particularly shown and described with respect to the illustrated embodiments thereof, it will be understood by those skilled in the art that the foregoing and other changes in for and details may be made therein without departing from the spirit and scope of the invention.

I claim:

1. An apparatus that is capable of heating edible fluid in a fully sealed manner without requiring external heating sources

2. The apparatus of claim 1, comprises of a penetrable tool with a chemical capable of producing an exothermic reaction inside, that can penetrate into the container and fully seal up the penetrated hole.

3. The apparatus as in claim 1, comprises of a manual vent system, that can be pulled out to release pressure and steam, and be push back in to reseal the opening created to prevent leakage.

4. The apparatus as in claim 1, comprises of a container that where the compartment with the activation chemical, is constructed lower than the compartment containing the edible fluid to prevent contamination of the edible fluid in case of leakage

5. The apparatus as in claim 1, comprises of a container that has an internal conducting wall that separates the edible fluid from the activation chemical to prevent contamination of the edible fluid. The conducting wall allows the edible fluid to get heated when the exothermic reaction occurs between the activation chemical and chemical pack tool.
